(19) United States
(12) Patent Application Publication
(10) Pub. No.: US 2019/0200576 A1
(43) Pub. Date: Jul. 4, 2019

(54) SYSTEMS AND METHODS FOR AN ANIMAL STORED AUXILARY LEASH

(71) Applicant: Christian Moore, Boulder, CO (US)

(72) Inventor: Christian Moore, Boulder, CO (US)

(21) Appl. No.: 15/862,530

(22) Filed: Jan. 4, 2018

(51) Int. Cl. A01K 27/00

(52) U.S. Cl. CPC A01K 27/003

(57) ABSTRACT

An animal stored leash system includes a leash section and an attachment mechanism, the attachment mechanism attached to a first end of the leash section. The system further includes a first ring, the first ring attached to a second end of the leash section. The system further includes a second ring, the second ring located along the leash section, approximately two thirds of a length of the leash section from the second end, the second ring sized to not fit through a first aperture in the first ring. The system further includes a third ring, the third ring located along the leash section, approximately one third of the length of the leash section from the second end, the third ring sized to not allow a stop portion of the attachment mechanism to pass through a second aperture in the third ring.

### BACKGROUND

Pet owners many times must walk or control their animals. In many scenarios, a leash is used to walk or control an owner's dog. The accessibility of a leash is critical to its usefulness and there are scenarios where a readily accessible leash may be critical to the owner's control of the pet. Additionally, leashes when not in use are typically detached from the animal's collar and therefore may be misplaced making them difficult to find.

### BRIEF SUMMARY

In one embodiment, an animal stored leash system includes a leash section and an attachment mechanism, the attachment mechanism attached to a first end of the leash section. The system further includes a first ring, the first ring attached to a second end of the leash section. The system further includes a second ring, the second ring located along the leash section, approximately two thirds of a length of the leash section from the second end, the second ring sized to not fit through a first aperture in the first ring. The system further includes a third ring, the third ring located along the leash section, approximately one third of the length of the leash section from the second end, the third ring sized to not allow a stop portion of the attachment mechanism to pass through a second aperture in the third ring. In one alternative, the attachment mechanism includes a clip for attaching to the first ring. In another alternative, the clip is sized to pass through the second aperture. Alternatively, the second end of the leash section is formed by folding a part of the leash section back to the leash section and attaching it to the leash section with a fourth ring, wherein the attachment mechanism is located at a fold point formed by the folding. Optionally, a length of the leash section from the fold point to the second end is approximately three times the circumference of an animal's neck used with the system. In one configuration, the system has a first configuration, the first configuration including the first end of the leash section passed through the first ring until the second ring prevents more of the leash section from passing through the first ring, and a remaining section of the leash section is passed to the third ring where the clip but not the stop portion passes through the third ring, and the clip is clipped to the first ring. Alternatively, at least one of the first ring and the third ring are formed by looping the leash section.

In another embodiment, an animal stored leash system includes a leash section and an attachment mechanism, the attachment mechanism attached to a first end of the leash section. The system further includes a first attacher, the first attacher attached to a second end of the leash section. The system further includes a second attacher, the second attacher located along the leash section, approximately two thirds of a length of the leash section from the second end, the second attacher sized to not fit through a first aperture in the first attacher. The system further includes a third attacher, the third attacher located along the leash section, approximately one third of the length of the leash section from the second end, the third attacher sized to not allow a stop portion of the attachment mechanism to pass through a second aperture in the third attacher. In one alternative, the attachment mechanism includes a clip for attaching to the first attacher. In another alternative, the clip is sized to pass through the second aperture. Alternatively, the second end of the leash section is formed by folding a part of the leash section back to the leash section and attaching it to the leash section with a fourth attacher, wherein the attachment mechanism is located at a fold point formed by the folding. Optionally, a length of the leash section from the fold point to the second end is approximately three times the circumference of an animal's neck used with the system. In one configuration, the system has a first configuration, the first configuration including the first end of the leash section passed through the first attacher until the second attacher prevents more of the leash section from passing through the first attacher, and a remaining section of the leash section is passed to the third attacher where the clip but not the stop portion passes through the third attacher, and the clip is clipped to the first attacher. Alternatively, the first attacher is attached to a collar. In another alternative, the first, second, and third attachers are rings. Optionally, the leash section is a braided cord. Alternatively, the leash section is a chain. In one alternative, the attachment mechanism includes a carabiner. Optionally, the stop portion is a ring. Alternatively, the fourth attacher is a ring.

In one embodiment, a method of storing a leash includes providing a leash including a leash section and an attachment mechanism, the attachment mechanism attached to a first end of the leash section. The leash further includes a first attacher, the first attacher attached to a second end of the leash section. The leash further includes a second attacher, the second attacher located along the leash section, approximately two thirds of a length of the leash section from the second end, the second attacher sized to not fit through a first aperture in the first attacher. The leash further includes a third attacher, the third attacher located along the leash section, approximately one third of the length of the leash section from the second end, the third attacher sized to not allow a stop portion of the attachment mechanism to pass through a second aperture in the third attacher. The method further includes passing the first end of the leash section through the first attacher until the second attacher prevents more of the leash section from passing through the first attacher. The method further includes passing a remaining section of the leash section to the third attacher where the clip but not the stop portion passes through the third attacher. The method further includes clipping the clip is to the first attacher. Alternatively, the method further includes attaching the first attacher to a collar on an animal. In another alternative, the method further includes wrapping the leash section around a neck of the animal before the clipping of the clip but after the passing the remaining section.

### BRIEF DESCRIPTION OF THE DRAWINGS

FIG. 1 shows one embodiment of a system for an animal stored auxiliary leash;

FIG. 2 shows another configuration of the system of FIG. 1;

FIG. 3 shows one embodiment of a system for an animal stored auxiliary leash;

FIG. 4 shows another configuration of the system of FIG. 3; and

FIG. 5 shows another embodiment of a system for an animal stored auxiliary leash.

### DETAILED DESCRIPTION

Certain terminology is used herein for convenience only and is not to be taken as a limitation on the embodiments of the systems and methods for an animal stored auxiliary leash (herein after “ASAL”). In various embodiments, the system includes a length of cord, rope, chain, or other material. This cord functions as the leash for the animal. Generally, the leash has two ends. At one end there is an attachment mechanism for attaching to the collar of the animal. Generally, this attachment mechanism is a carbiner type attachment mechanism, however, any clip or other item that will allow attachment to a collar of an animal may be used.

In many embodiments, the length of the leash provided is approximately three times the length of the collar of the animal. When stored, the leash wraps around the animal's neck in a similar fashion to the collar. Furthermore, the leash is configured to be tripled around the animal's neck or other portion of the animal for storage purposes.

Enabling the tripling of the device is enabled by 3 rings oriented on the leash. Although in many embodiments, these devices are described as rings, it is not necessary that they be rings. Simply, the first ring has an aperture through which the second ring may not pass. The third ring has an aperture through which some portion of the attachment mechanism may not pass. The first ring is located on the end of the leash, opposite the attachment mechanism. The second ring is located approximately two thirds of the length of the leash from the first ring. The third ring is located between the first and second ring, approximately a third of the length of the leash. The attachment mechanism should be able to fit through the first ring as well. Therefore, in order to triple the leash, the attachment mechanism is passed through the first ring, until the first ring reaches the second ring, through which the second ring may not pass. Then the leash is essentially folded at the point where the second ring interfaces with the first ring, such that the attachment mechanism may be passed partially through the third ring. The attachment mechanism may then be clipped to the first ring or the first ring and the second ring. In many embodiments, the third ring may be a locking ring that may be opened and clipped to a ring of the collar of the animal. Alternatively, the third ring may be on the collar of the animal. In some alternatives, the second ring may merely be a first stopper. This has the disadvantage of the attachment mechanism of not being able to attach to it when the device is tripled, however, the device would still function.

Additionally, in order to adjust the lengths of the segments, the end of the leash where the attachment mechanism is attached, may actually be a looped or folded leash section. In this way, a cord may be provided that is of a length that may be adjusted to fit various neck sizes of an animal. Essentially, the user takes a length of rope that is more than 3 times the length needed to wrap around the neck of the animal. At the end of the length of three times the animal's neck, the user folds the leash and places the attachment mechanism at this fold. At the end of the folded over end, the user attaches the end to the leash.

In many embodiments, rings of various sizes are used. These rings may be key chain rings in the case of leash being composed of a braided rope. The rings may be opened and attached to the braided rope (or cord). Alternatively, the leash may be a chain of metal, or a chain of plastic. The rings may be rings with a spring loaded hinged section. In some embodiments, the rings may be pieces of the leash itself that have been looped. In such a scenario, the leash may be looped into a ring at the needed points and tied off, clamped, or otherwise maintained in a loop. Additionally, the leash may be a plastic or nylon type material that has a ribbon like structure. The ribbon structure may have holes at various points along the material, such that the rings may be attached at those points. Although rings are generally described as being used herein, since it is predictable which size rings will or will not pass through other rings (a ring of a larger diameter will not pass through a ring of a smaller diameter, regardless of the orientation). Generically, rings or other shapes and size of items that could function like the rings are referred to as attachers herein. To operate according to many embodiments described herein the attachers should be attachable at the proper point along the leash and should allow or not allow another attacher to pass through an aperture in the attacher as noted. Generally in many embodiments described, the first attacher (ring) should allow the attachment mechanism to pass through and allow the third attacher (ring) to pass through, but not the second. Additionally, the third attacher should not allow the entirety of the attachment mechanism to pass through its aperture, merely the clip end or other end that allows for attachment to the first attacher.

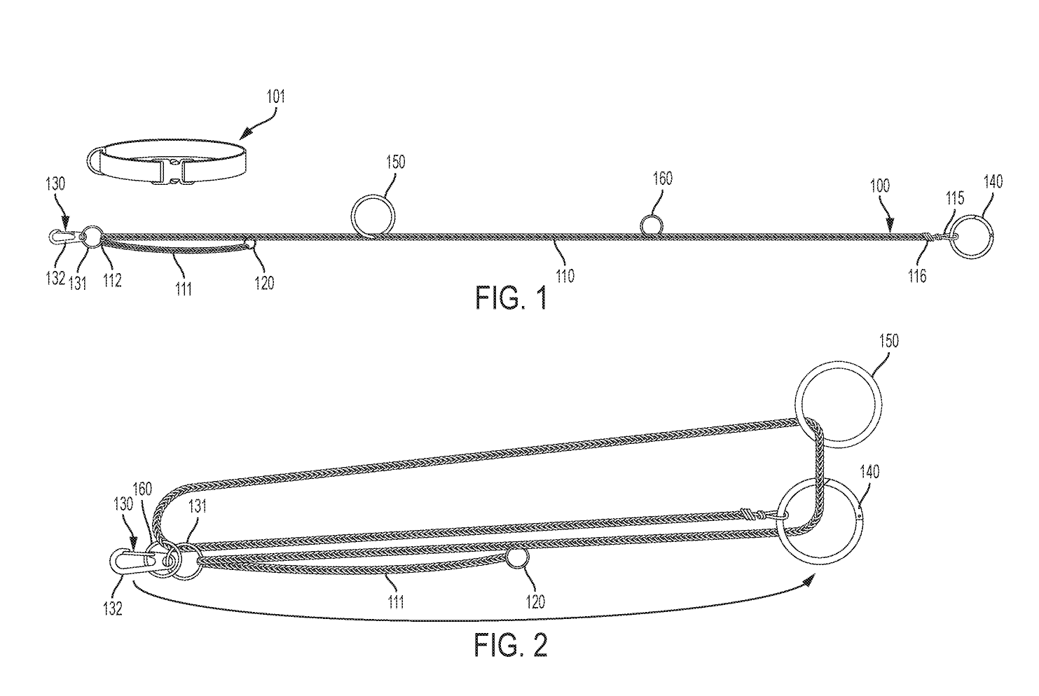

FIG. 1 shows one embodiment of an ASAL 100 and a collar 101 in an extended position. Generally, ASAL 100 includes a braided rope 110. At one end of braided rope 110, the rope has been folded to create a folded section 111 that is attached to the braided rope 110 itself, via fourth ring 120. At the fold point 112 of the folded section 111, the attachment mechanism 120 is attached. Attachment mechanism 130 includes an attachment ring 131 and a carabiner section 132 (or other item that may be used to clip; the carabiner and other items that might similarly function may be referred to as a “clip”). As will be later explained, ring 131 is of such as size that it may not pass through the third ring 160.

At the end of the ASAL 100 a first ring 140 is attached to the braided rope 110 through a loop 115 in the braided rope 110. Shown is a braided loop 110 with FIG. 8 knots 116 creating a loop 115. Various other possibilities for braiding and tying may be used. First ring 140 has a hinged section 141, such that the ring 140 may be attached to collar 101. At a point two thirds of the length of the braided rope 110 from loop 115 to fold point 112, ring 150 is attached to the braided rope 110. Ring 150 is a keychain like ring that may be opened and slid off and on of the braided rope 110. The size of ring 150 (also referred to as the second ring and alternatively as a stopper ring) is such that ring 150 may pass through ring 140.

Additionally, ASAL includes a third ring 160. Third ring 160 is located half way between first ring 140 and second ring 150 or one third of the length of the braided rope 110 from loop 115 to fold point 112. Ring 160 is sized such that ring 131 does not fit through it, but such that carabiner section may pass through. Like ring 150, ring 160 is a keychain like ring that may be opened and slid off and on of the braided rope 110.

Similar to the above description, in order to store the ASAL 100, the end having the attachment mechanism 130 is passed through ring 140 until ring 150 reaches ring 140, at which point the ring 150 will not be able to pass through ring 140. The end having the attachment mechanism 130 is then passed through ring 160, until ring 131 is stopped by ring 160. At this point, the ASAL is tripled and may be clipped to ring 140 via carabiner section 132. This configuration is shown in FIG. 2.

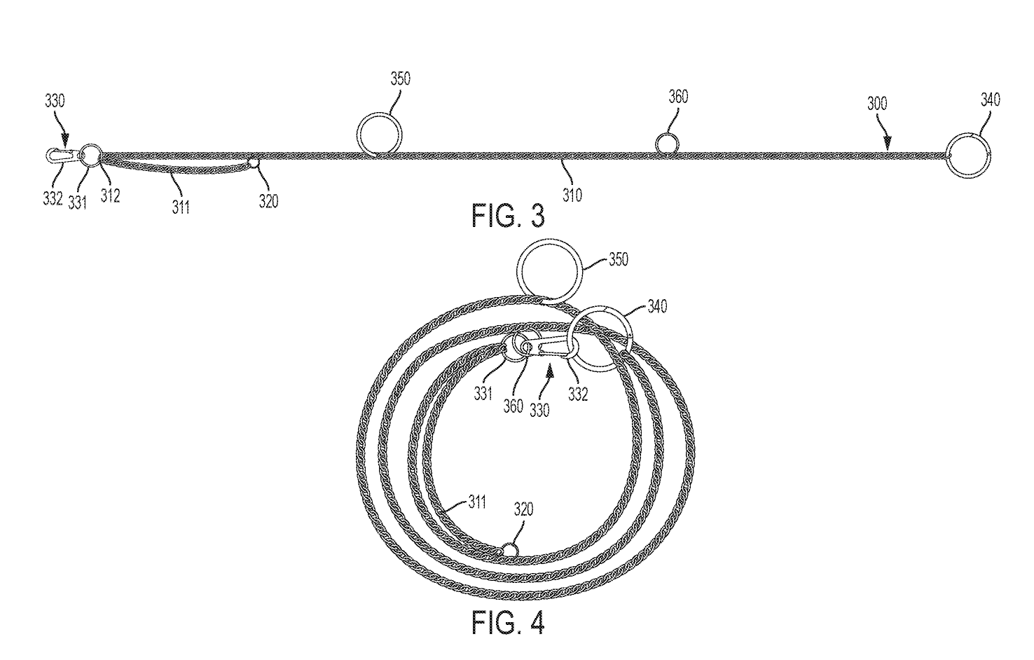

Additionally, FIG. 3 shows an extended version of a chain version of ASAL 300 and a collar 101 in an extended position. Generally, ASAL 300 includes a chain 310. At one end of chain 310, the chain has been folded to create a folded section 311 that is attached to the chain 310 itself, via fourth ring 320. At the fold point 312 of the folded section 311, the attachment mechanism 320 is attached. Attachment mechanism 330 includes an attachment ring 331 and a carabiner section 332. As will be later explained, ring 331 is of such as size that it may not pass through the third ring.

At the end of the ASAL 300 a first ring 340 is attached to the chain 310 through a link 315 of chain 310. First ring 340 has a hinged section 341, such that the ring 340 may be attached to collar 101. At a point two thirds of the length of the chain 310 from link 315 to fold point 312, ring 350 is attached to the chain 310. Ring 350 is a hinged ring like ring 340. The size of ring 350 (also referred to as the second ring) is such that ring 350 may pass through ring 340.

Additionally, ASAL includes a third ring 360. Third ring 360 is located half way between first ring 340 and second ring 350 or one third of the length of the braided rope 310 from link 315 to fold point 312. Ring3 is sized such that ring 331 does not fit through it, but such that carabiner section may pass through. Ring 360 is a hinged ring like ring 340.

Similar to the above description, in order to store the ASAL 300, the end having the attachment mechanism 330 is passed through ring 340 until ring 350 reaches ring 340, at which point the ring 350 will not be able to pass through ring 340. The end having the attachment mechanism 330 is then passed through ring 360, until ring 331 is stopped by ring 360. At this point, the ASAL is tripled and may be clipped to ring 340 via carabiner section 332. This configuration is shown in FIG. 4.

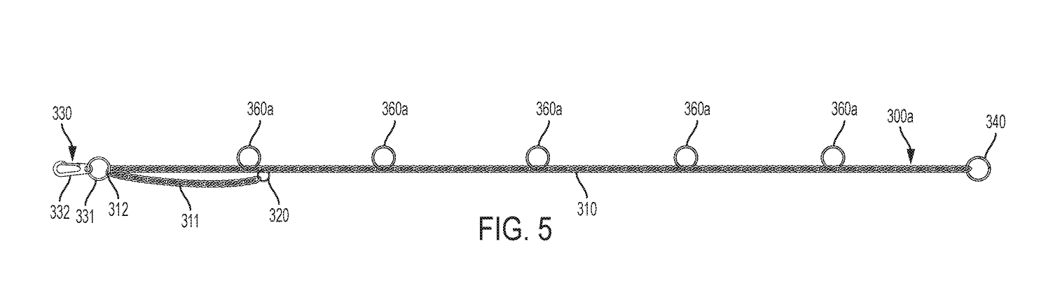

FIG. 5 shows a similar, but different embodiment to that shown in FIG. 4. In FIG. 5, an ASAL 300a is shown. Similar to that of FIG. 4, ASAL 300a includes a chain 310. At one end of chain 310, the chain has been folded to create a folded section 311 that is attached to the chain 310 itself, via fourth ring 320. At the fold point 312 of the folded section 311, the attachment mechanism 320 is attached. Attachment mechanism 330 includes an attachment ring 331. In ASAL 300a, the system is, in contrast, designed to have the rings 360a all clip into carabiner section 340. Therefore, in the embodiment of FIG. 5, the space between each ring 360a, the space between attachment mechanism 330 and the nearest ring 360a, and the space between carabiner section 340 and the nearest ring 360a, is the length needed to wrap around the animal's neck once. Therefore, in usage, the attachment mechanism 340 may be clipped to the collar and then the length of chain 310 to the nearest ring 360a wrapped around the neck of the animal. This ring 360a is then clipped into attachment mechanism 340. Then the next length of chain 310 to the next ring 360a is wrapped around the neck of the animal and then clipped into attachment mechanism 340. The process is repeated until all of the lengths are wrapped around the next of the animal and the end ring 331 is clipped to the attachment mechanism 340. In such a configuration, the size of the rings has little importance, as long as they may be clipped.

While specific embodiments have been described in detail in the foregoing detailed description, it will be appreciated by those skilled in the art that various modifications and alternatives to those details could be developed in light of the overall teachings of the disclosure and the broad inventive concepts thereof. It is understood, therefore, that the scope of this disclosure is not limited to the particular examples and implementations disclosed herein but is intended to cover modifications within the spirit and scope thereof as defined by the appended claims and any and all equivalents thereof.

What is claimed as new and desired to be protected by Letters Patent of the United States is:

1. An animal stored leash system, the system comprising:
a leash section;
an attachment mechanism, the attachment mechanism attached to a first end of the leash section;
a first ring, the first ring attached to a second end of the leash section;
a second ring, the second ring located along the leash section, approximately two thirds of a length of the leash section from the second end, the second ring sized to not fit through a first aperture in the first ring;
a third ring, the third ring located along the leash section, approximately one third of the length of the leash section from the second end, the third ring sized to not allow a stop portion of the attachment mechanism to pass through a second aperture in the third ring.

2. The system of claim 1, wherein the attachment mechanism includes a clip for attaching to the first ring.

3. The system of claim 2, wherein the clip is sized to pass through the second aperture.

4. The system of claim 3, wherein the second end of the leash section is formed by folding a part of the leash section back to the leash section and attaching it to the leash section with a fourth ring, wherein the attachment mechanism is located at a fold point formed by the folding.

5. The system of claim 4, wherein a length of the leash section from the fold point to the second end is approximately three times the circumference of an animal's neck used with the system.

6. The system of claim 5, wherein the system has a first configuration, the first configuration including the first end of the leash section passed through the first ring until the second ring prevents more of the leash section from passing through the first ring, and a remaining section of the leash section is passed to the third ring where the clip but not the stop portion passes through the third ring, and the clip is clipped to the first ring.

7. The system of claim 1, wherein at least one of the first ring and the third ring are formed by looping the leash section.

8. An animal stored leash system, the system comprising:
a leash section;
an attachment mechanism, the attachment mechanism attached to a first end of the leash section;
a first attacher, the first attacher attached to a second end of the leash section;
a second attacher, the second attacher located along the leash section, approximately two thirds of a length of the leash section from the second end, the second attacher sized to not fit through a first aperture in the first attacher;
a third attacher, the third attacher located along the leash section, approximately one third of the length of the leash section from the second end, the third attacher sized to not allow a stop portion of the attachment mechanism to pass through a second aperture in the third attacher.

9. The system of claim 8, wherein the attachment mechanism includes a clip for attaching to the first attacher.

10. The system of claim 9, wherein the clip is sized to pass through the second aperture.

11. The system of claim 10, wherein the second end of the leash section is formed by folding a part of the leash section back to the leash section and attaching it to the leash section with a fourth attacher, wherein the attachment mechanism is located at a fold point formed by the folding.

12. The system of claim 11, wherein a length of the leash section from the fold point to the second end is approximately three times the circumference of an animal's neck used with the system.

13. The system of claim 12, wherein the system has a first configuration, the first configuration including the first end of the leash section passed through the first attacher until the second attacher prevents more of the leash section from passing through the first attacher, and a remaining section of the leash section is passed to the third attacher where the clip but not the stop portion passes through the third attacher, and the clip is clipped to the first attacher.

14. The system of claim 8, wherein the first attacher is attached to a collar.

15. The system of claim 8, wherein the first, second, and third attachers are rings.

16. The system of claim 8, wherein the leash section is a braided cord.

17. The system of claim 8, wherein the leash section is a chain.

18. The system of claim 8, wherein the attachment mechanism includes a carabiner.

19. The system of claim 18, wherein the stop portion is a ring.

20. The system of claim 11, wherein the fourth attacher is a ring.

21. A method of storing a leash, the method comprising:
providing a leash including:
a) a leash section;
b) an attachment mechanism, the attachment mechanism attached to a first end of the leash section, the attachment mechanism including a clip;
c) a first attacher, the first attacher attached to a second end of the leash section;
d) a second attacher, the second attacher located along the leash section, approximately two thirds of a length of the leash section from the second end, the second attacher sized to not fit through a first aperture in the first attacher;
e) a third attacher, the third attacher located along the leash section, approximately one third of the length of the leash section from the second end, the third attacher sized to not allow a stop portion of the attachment mechanism to pass through a second aperture in the third attacher;
passing the first end of the leash section through the first attacher until the second attacher prevents more of the leash section from passing through the first attacher;
passing a remaining section of the leash section to the third attacher where the clip but not the stop portion passes through the third attacher;
clipping the clip is to the first attacher.

22. The method of claim 21 further comprising:
attaching the first attacher to a collar on an animal.

23. The method of claim 23, further comprising:
wrapping the leash section around a neck of the animal before the clipping of the clip but after the passing the remaining section.
